(19) United States
(12) Patent Application Publication
(10) Pub. No.: US 2006/0104617 A1
(43) Pub. Date: May 18, 2006

(54) Signal output apparatus and signal output method

(75) Inventors: Takanobu Mukaide, Tachikawa-shi (JP); Kazuyuki Okano, Ome-shi (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/258,863

(22) Filed: Oct. 27, 2005

(30) Foreign Application Priority Data
Oct. 29, 2004 (JP) 2004-316844

(51) Int. Cl. H04N 7/04; H04N 7/06

(52) U.S. Cl. 386/97; 386/96

(57) ABSTRACT

A signal output apparatus includes a processing unit configured to generate selected one of a video signal and an audio signal and output the signal in a plurality of output forms, a plurality of output units configured to output each of the signals generated by the processing unit, a setting unit configured to set a receiver connected to each of the plurality of output units, and a control unit configured to output the output signal of the processing unit from each of the plurality of output units in an output form corresponding to the receiver set by the setting unit.

### CROSS-REFERENCE TO RELATED APPLICATIONS

This application is based upon and claims the benefit of priority from prior Japanese Patent Application No. 2004-316844, filed Oct. 29, 2004, the entire contents of which are incorporated herein by reference.

### BACKGROUND OF THE INVENTION

1. Field of the Invention

The present invention relates to a signal output apparatus and a signal output method for outputting video and audio signals to a separate receiver connected to an external device.

2. Description of the Related Art

As is well known, the digital visual interface (DVI) standard has extended as a standard to transmit a digital video signal. In recent years, a high definition multimedia interface (HDMI) standard has come to be employed as a digital signal transmission standard improved over the DVI standard.

The HDMI standard, unlike the DVI standard, contains various provisions that the digital audio signal can be multiplexed and transmitted during the blanking period of the digital video signal, that the digital video signal can be transmitted in the form of the YCbCr signal or the YPbPr signal of higher quality as well as in the form of the RGB signal, and that a small-sized HDMI connector like universal serial bus (USB) can be used.

In the case where the video/audio signal is transmitted according to the HDMI standard, the transmitter and the receiver authenticate each other, and in accordance with the performance of the receiver, the output form of the transmitter is automatically set. In the case where the transmitter is a digital versatile disk (DVD) player and the receiver is a TV receiver adapted for stereo 2-channel audio output, for example, the DVD player is set to output the audio signal in stereo 2-channel by the authentication with the TV receiver.

Consider a case in which the TV receiver described above is connected to the DVD player according to the HDMI standard, and an audio amplifier adapted for multichannels is connected by other means. Even though the audio amplifier may be adapted for 6-channel audio input, the DVD player is set to output the audio signal in two channels by the authentication with the TV receiver.

Jpn. Pat. Appln. KOKAI Publication No. 2004-96238 discloses a technique in which the DVD player receives the output control information from an AV amplifier and determines the output channel of the audio signal based on the output control information, while downmixing to the output channel determined based on the output control information when decoding the audio data recorded in the DVD.

### BRIEF SUMMARY OF THE INVENTION

According to one aspect of the present invention, there is provided a signal output apparatus comprising: a processing unit configured to generate selected one of a video signal and an audio signal and output the signal in a plurality of output forms; a plurality of output units configured to output each of the signals generated by the processing unit; a setting unit configured to set a receiver connected to each of the plurality of output units; and a control unit configured to output the output signal of the processing unit from each of the plurality of output units in an output form corresponding to the receiver set by the setting unit.

According to another aspect of the present invention, there is provided a signal output method comprising: a first step of generating a signal corresponding to selected one of video form and audio form and outputting the signal in a plurality of output forms; a second step of setting a receiver connected to a plurality of output units to output the signal generated in the first step; and a third step of causing the signal generated in the first step to be output from the plurality of output units, respectively, in an output form corresponding to the receiver set in the second step.

### BRIEF DESCRIPTION OF THE SEVERAL VIEWS OF THE DRAWING

FIG. 1 is a block diagram showing a configuration for explaining a transmission system according to an embodiment of the invention;

FIG. 2 is a flowchart for explaining the main operation of an optical disk reproduction apparatus according to the embodiment;

FIG. 3 is a diagram for explaining an example of an audio output set screen displayed by the optical disk reproduction apparatus according to the embodiment;

FIG. 4 is a block diagram showing a configuration for explaining a modification of the optical disk reproduction apparatus according to the embodiment;

FIG. 5 is a block diagram showing a configuration for explaining another modification of the optical disk reproduction apparatus according to the embodiment; and

FIG. 6 is a block diagram showing a configuration for explaining a transmission system according to another embodiment of the invention.

### DETAILED DESCRIPTION OF THE INVENTION

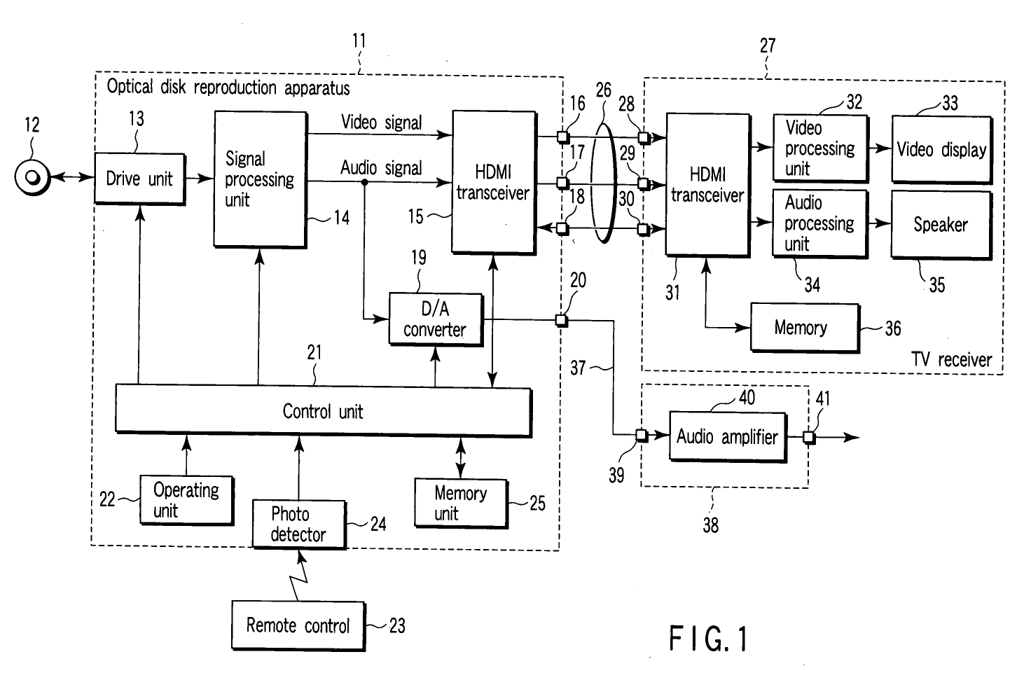

An embodiment of the invention is described in detail below with reference to the drawings. FIG. 1 shows a transmission system according to this embodiment. First, reference numeral 11 designates an optical disk reproduction apparatus making up a signal transmitter.

The optical disk reproduction apparatus 11 reads the recording data from an optical disk 12 such as a DVD mounted on a drive unit 13. The data read by the drive unit 13 is supplied to a signal processing unit 14, and through a digitization process, an error correcting process and a decoding process in that order, restored to a digital video signal and a digital audio signal.

This signal processing unit 14 can perform selected one of the operation to output the restored digital audio signal in multichannels, say, 6 channels and the operation to downmix the multichannel audio output as a 2-channel signal.

After that, the digital video and audio signals restored by the signal processing unit 14 are supplied to an HDMI transceiver 15, converted into a form conforming to the HDMI standard and output through a video output terminal 16 and an audio output terminal 17. The HDMI transceiver 15 also transmits and receives the control data to and from an external source through a control input/output terminal 18.

Further, the digital audio signal restored by the signal processing unit 14 is supplied to a digital/analog (D/A) converter 19, converted into an analog audio signal, and output to an external device through an audio output terminal 20.

In this optical disk reproduction apparatus 11, the entire operation including the reproducing operation described above is centrally controlled by a control unit 21. The control unit 21 has built therein a central processing unit (CPU), and upon receipt of the operating information from an operating unit 22 or the operating information sent from a remote control 23 through a photo detector 24, controls each part in such a manner as to reflect the specific operation thereof.

In this case, the control unit 21 uses a memory unit 25. The memory unit 25 mainly includes a read-only memory (ROM) for storing the control program executed by the CPU, a random access memory (RAM) for supplying the working area to the CPU and a nonvolatile memory for storing various setting information and control information.

The video output terminal 16, the audio output terminal 17 and the control input/output terminal 18 are connected through a transmission path 26 based on the HDMI standard to a video input terminal 28, an audio input terminal 29 and a control input/output terminal 30, respectively, of a TV receiver 27, which makes up a signal receiver.

The digital video signal supplied to the video input terminal 28 is supplied to an HDMI transceiver 31 and restored to the digital video signal before conversion by the HDMI transceiver 15, after which the digital video signal is supplied to a video processing unit 32 where it is converted into a form adapted for display. Then, the digital video signal is displayed visually on a video display unit 33 of a liquid crystal panel or the like.

The digital audio signal supplied to the audio input terminal 29, on the other hand, is supplied to the HDMI transceiver 31 and restored to the digital audio signal before conversion by the HDMI transceiver 15, after which the digital audio signal is supplied to an audio processing unit 34 where it is amplified into a form adapted for audio reproduction and output as a reproduced sound through a speaker 35.

The audio output of the TV receiver 27 is in stereo two channels, and the attribute information such as the number of audio output channels and the resolution of the video display unit 33 is stored in a memory 36 of the TV receiver 27.

Therefore, in the case where the TV receiver 27 is connected through the transmission path 26, the control unit 21 of the optical disk reproduction apparatus 11 reads the attribute information from the memory 36 through the HDMI transceiver 15, the control input/output terminals 18, 30 and the HDMI transceiver 31, and stores it in the nonvolatile memory of the memory unit 25.

The audio output terminal 20, on the other hand, is connected to the audio input terminal 39 of the audio amplifier 38 making up a signal receiver through a transmission path 37 corresponding to the transmission means not conforming to the HDMI standard. The analog audio signal supplied through the audio input terminal 39 is amplified by an audio amplifier 40, for example, adapted for multichannels of, say, six channels, and supplied to an external speaker or the like through an audio output terminal 41 for audio reproduction.

Normally, the control unit 21 causes the signal processing unit 14 to execute the downmixing processing based on the attribute information of the TV receiver 27 in such a manner as to output the audio signal of the number of audio channels, i.e. two channels of the TV receiver 27. As a result, the audio signal supplied to the audio amplifier 38 is also converted to two channels.

In view of this, according to this embodiment, the user, by operating the operating unit 22 or the remote control 23, can arbitrarily determine whether the signal processing unit 14 outputs the audio signal in two or six channels, i.e. whether the function of the TV receiver 27 or the function of the audio amplifier 38 is given priority.

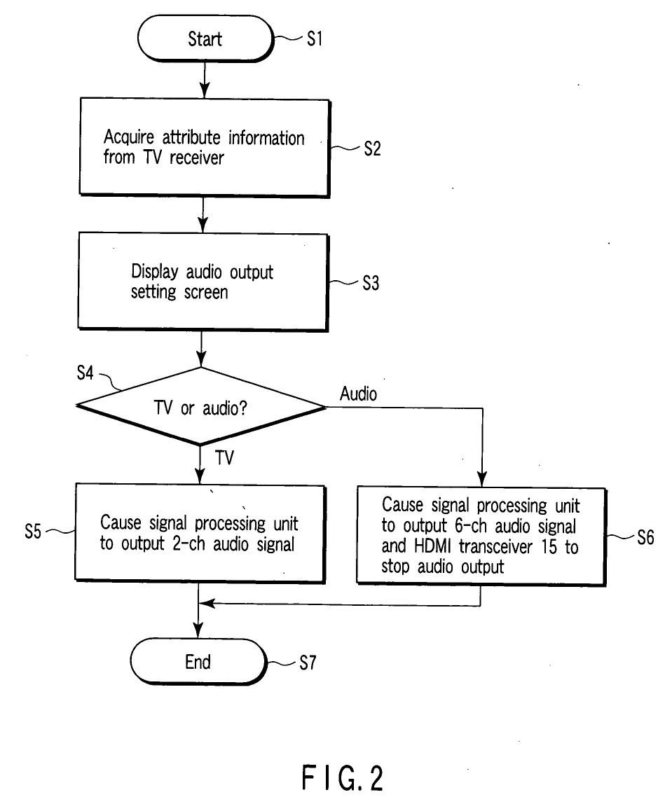

FIG. 2 shows a flowchart summarizing this select operation. First, the TV receiver 27 is connected to the optical disk reproduction apparatus 11 according to the HDMI standard thereby to start the process (step Si). Then, in step S2, the control unit 21 acquires the attribute information from the memory 36 of the TV receiver 27 and recognizes the number of audio channels that can be output by the TV receiver 27.

After that, in step S3, the control unit 21, based on the user operation, displays on the video display unit 33 an audio output setting screen for setting whether the function of the TV receiver 27 or the function of the audio amplifier 38 is given priority.

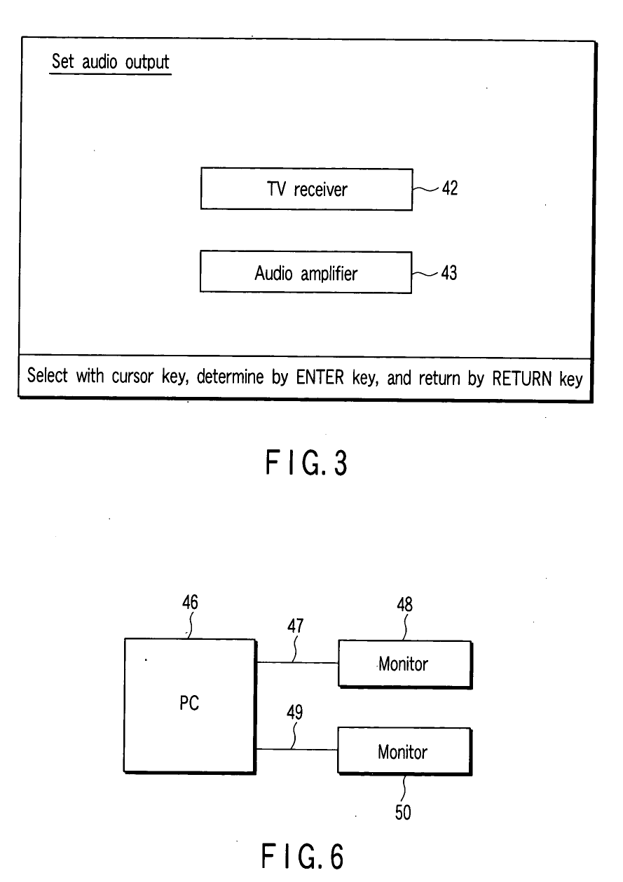

As shown in FIG. 3, an item 42 ‘TV receiver’ and an item 43 ‘audio amplifier’ are displayed on the audio output setting screen. One of the items 42, 43 is selected by a cursor key arranged on the remote control 23, and by operating an ENTER key, the setting is completed. The result of setting the audio output is stored in the nonvolatile memory of the memory unit 25.

Assume that the audio output is set by the user in this way. The control unit 21, upon receipt of a request for reproduction by the optical disk 12, determines in step S4 whether the function of the TV receiver 27 or the function of the audio amplifier 38 is set as a priority.

In the case where the function of the TV receiver 27 is set as a priority, the control unit 21 causes, in step S5, the signal processing unit 14 to downmix to output the number of audio channels, i.e. the 2-channel audio signal of the TV receiver 27, thereby ending the process (step S7). As a result, the TV receiver 27 and the audio amplifier 38 are both supplied with a 2-channel audio signal.

Upon determination in step S4 that the function of the audio amplifier 38 is set as a priority, on the other hand, the control unit 21 causes, in step S6, the signal processing unit 14 to output the 6-channel audio signal, while at the same time causing the HDMI transceiver 15 to stop outputting the audio signal thereby to end the process (step S7). As a result, the audio signal is not supplied to the TV receiver 27 which operates only for video display, while the audio amplifier 38 can output the 6-channel audio signal.

According to the embodiment described above, it is possible for a user to select as desired whether the signal processing unit 14 is caused to output the audio signal corresponding to the function of the TV receiver 27 or the audio output corresponding to the function of the audio amplifier 38. Thus, the inconvenience that the audio output form might otherwise be uniquely determined based on the HDMI standard is eliminated and a versatile application can be implemented.

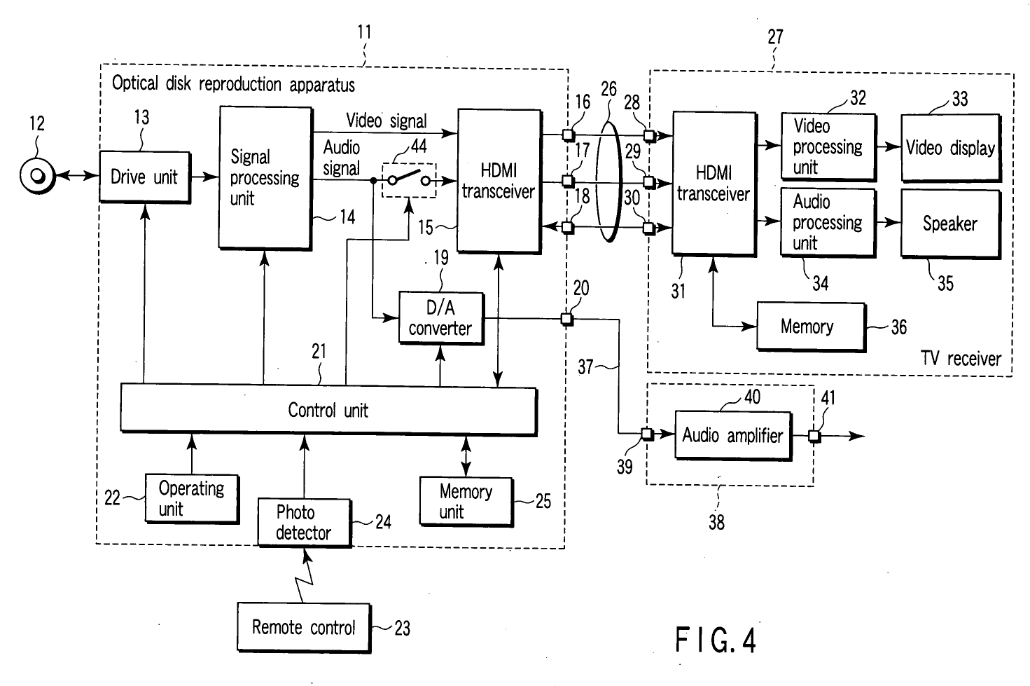

FIG. 4 shows a modification of the embodiment described above. In FIG. 4, the same component parts as in FIG. 1 are designated by the same reference numerals, respectively. A switch 44 is interposed on an audio signal transmission line connecting a signal processing unit 14 and an HDMI transceiver 15.

In the case where the user sets the function of an audio amplifier 38 as a priority, a control unit 21 causes the signal processing unit 14 to execute the process to output a 6-channel audio signal, while at the same time controlling the switch 44 to the off state not to supply the audio signal to the HDMI transceiver 15. With this configuration, the HDMI transceiver 15 is not required to have the function to stop the audio signal, and therefore the configuration of the HDMI transceiver 15 can be simplified.

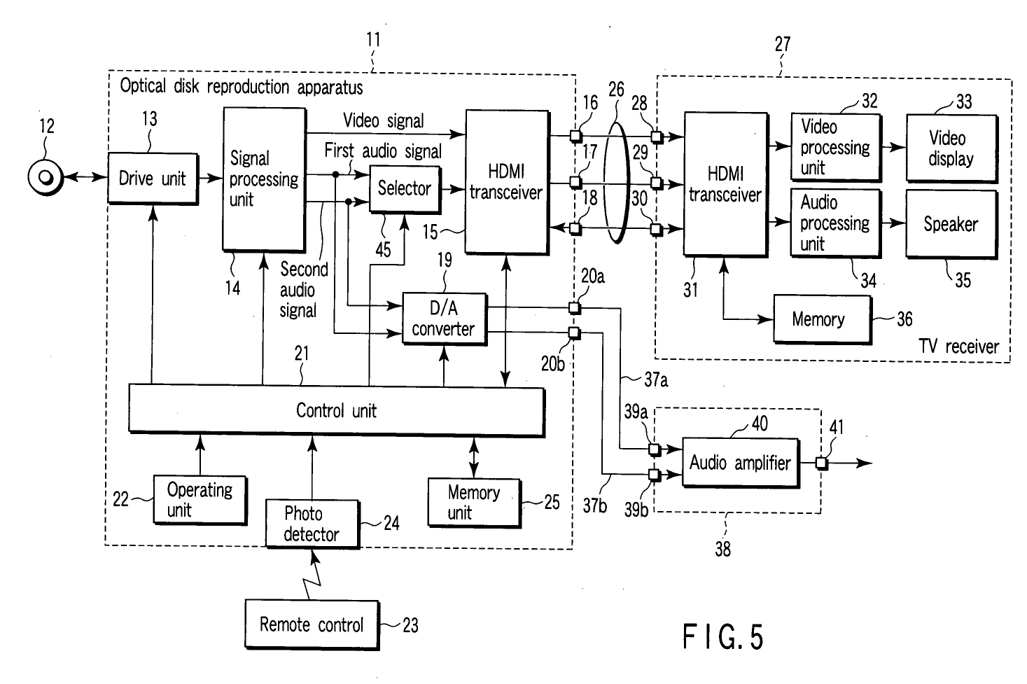

FIG. 5 shows another modification of the embodiment described above. In FIG. 5, the same component parts as in FIG. 1 are designated by the same reference numerals, respectively. A signal processing unit 14 can output both a 6-channel first audio signal constituting an original signal recorded in an optical disk 12 and a 2-channel second audio signal downmixed from the first audio signal.

The first and second audio signals are selectively supplied to an HDMI transceiver 15 by a selector 45. In this case, a control unit 21, based on the attribute information acquired from a TV receiver 27, controls the selector 45 to select the first audio signal in the case where the TV receiver 27 can output the 6-channel audio signal and select the second audio signal in the case where the TV receiver 27 can output the 2-channel audio signal.

The first audio signal and the second audio signal are both supplied to an audio amplifier 38 through a D/A converter 19, audio output terminals 20a, 20b, transmission paths 37a, 37b, and audio input terminals 39a, 39b. The audio amplifier 38 amplifies and outputs the input first or second audio signal, whichever is designated by the user.

With the configuration shown in FIG. 5, the TV receiver 27 and the audio amplifier 38 can each select the audio mode conveniently for practical purposes.

FIG. 6 shows another embodiment of the invention. Specifically, a PC (personal computer) 46 can output a digital video signal to a high-resolution monitor 48 through a digital transmission line 47 based on the DVI standard. Also, the PC 46 can output the analog video signal to a low-resolution monitor 50 through an analog transmission line 49.

The PC 46 can be set by the user selectively in any of three modes including a mode in which the digital video signal is output to the monitor 48 while the analog video signal is not output to the monitor 50, a mode in which the digital video signal is not output to the monitor 48 while the analog video signal is output to the monitor 50, and a mode in which the digital video signal is output to the monitor 48 while the analog video signal is output to the monitor 50.

According to this embodiment, the user can selectively cause the PC 46 to output the video signal corresponding to the function of the monitor 48 or the monitor 50 as desired, and therefore the video output form is prevented from being uniquely determined inconveniently, thereby realizing a versatile form of applications.

According to each of the embodiments described above, the information is transmitted by connecting the optical disk reproduction apparatus 11 to the TV receiver 27 and the audio amplifier 38 through the transmission paths 26, 37, and also by connecting the PC 46 to the monitors 48,. 50 through the transmission paths 47, 49. Nevertheless, the information may alternatively be transmitted between the transmitter and the receiver not by cable but by radio.

This invention is not limited to the embodiments described above, and the constituent elements thereof can be variously modified and embodied without departing from the spirit and scope of the invention. Also, various aspects of the invention can be formed by appropriately combining a plurality of the constituent elements disclosed in the embodiments described above. For example, some of the constituent elements may be deleted from all the constituent elements shown in the embodiments. Further, the constituent elements of different embodiments may be combined with each other appropriately.

What is claimed is:

1. A signal output apparatus comprising:
a processing unit configured to generate selected one of a video signal and an audio signal and output the signal in a plurality of output forms;
a plurality of output units configured to output each of the signals generated by the processing unit;
a setting unit configured to set a receiver connected to each of the plurality of output units; and
a control unit configured to output the output signal of the processing unit from each of the plurality of output units in an output form corresponding to the receiver set by the setting unit.

2. A signal output apparatus according to claim 1, wherein the setting unit comprises an acquisition unit configured to acquire attribute information of a first receiver from the first receiver connected to a first one of the plurality of output units for receiving the signal output from the first output unit, and the output form of the signal from the first output unit is set based on the attribute information acquired by the acquisition unit.

3. A signal output apparatus according to claim 2, wherein the setting unit sets the output form of the signal from a second one of the plurality of output units to the same output form as the signal from the first output unit in the case where the output form of the signal from the first output unit is set based on the attribute information acquired by the acquisition unit.

4. A signal output apparatus according to claim 2, further comprising a stopper configured to stop the signal supply to the first output unit in the case where the output form of the signal from the second one of the plurality of output units is set in such a manner as to correspond to a second receiver connected to the second output unit for receiving the signal output from the second output unit.

5. A signal output apparatus according to claim 2, further comprising a selector configured to selectively supply the first output unit with the signal output in a plurality of output forms from the processing unit based on the attribute information acquired by the acquisition unit.

6. A signal output apparatus according to claim 1, wherein the setting unit is configured to display a screen for designating a specified one of a plurality of receivers connected to the plurality of output units, respectively.

7. A signal output apparatus according to claim 1, wherein the processing unit is configured to output the audio signal in both an output form corresponding to multichannels and an output form with multichannel audio signal downmixed.

8. A signal output method comprising:
a first step of generating a signal corresponding to selected one of video form and audio form and outputting the signal in a plurality of output forms;
a second step of setting a receiver connected to a plurality of output units to output the signal generated in the first step; and
a third step of causing the signal generated in the first step to be output from the plurality of output units, respectively, in an output form corresponding to the receiver set in the second step.

9. A signal output method according to claim 8, wherein the second step comprises the steps of:
acquiring attribute information of a first receiver from the first receiver connected to a first one of the plurality of output units for receiving the signal output from the first output unit; and
setting the output form of the signal from the first output unit based on the attribute information acquired at the acquisition step.

10. A signal output system comprising:
an output unit configured to output a signal corresponding to selected one of video form and audio form from a plurality of output terminals of a transmitter in a plurality of output forms;
a setting unit configured to cause the transmitter to set a receiver connected to each of the plurality of output terminals; and
a control unit configured to cause the signal to be output from each of the plurality of output terminals in an output form corresponding to the receiver set by the setting unit.
